(19) United States
(12) Patent Application Publication
(10) Pub. No.: US 2026/0148682 A1
(43) Pub. Date: May 28, 2026

(54) PIXEL, DISPLAY DEVICE INCLUDING THE PIXEL, AND ELECTRONIC DEVICE INCLUDING THE DISPLAY DEVICE

(71) Applicant: Samsung Display Co., Ltd., Yongin-si (KR)

(72) Inventor: JUNHYUN PARK, Yongin-si (KR)

(21) Appl. No.: 19/271,582

(22) Filed: Jul. 16, 2025

(30) Foreign Application Priority Data
Nov. 22, 2024 (KR) 10-2024-0168173

(51) Int. Cl. G09G 3/32

(52) U.S. Cl. CPC G09G 3/32; G09G 2300/0819; G09G 2300/0842; G09G 2300/0861; G09G 2310/08; G09G 2320/0233

(57) ABSTRACT

In a display device, each of an address-scan period and a self-scan period includes a data initialization period and an anode initialization period, and a voltage of an anode electrode is initialized in the data initialization period and the anode initialization period. That is, the voltage of the anode electrode may be initialized multiple times.

### CROSS-REFERENCE TO RELATED APPLICATION

The present application claims priority to and the benefit of Korean Patent Application No. 10-2024-0168173, filed on Nov. 22, 2024, in the Korean Intellectual Property Office, the entire disclosure of which is incorporated herein by reference.

### BACKGROUND

### 1. Field

Aspects of some embodiments of the present disclosure relates to a pixel, a display device including the pixel, and an electronic device including the display device.

### 2. Description of the Related Art

In general, a display device includes a display panel and a display panel driver. The display panel includes gate lines, data lines, emission lines, and pixels. The display panel driver includes a gate driver for providing a gate signal to the gate lines, a data driver for providing a data voltage to the data lines, an emission driver for providing an emission signal to the emission lines, and a driving controller for controlling the gate driver, the data driver, and the emission driver.

The display device may support a variable driving frequency, and a frame period for each of the pixels may include an address-scan period and a self-scan period. An anode initialization operation may be performed to initialize a voltage of an anode electrode of a light emitting element included in each of the pixels in each of the address-scan period and the self-scan period.

The light emitting element may emit a light based on the voltage of the anode electrode and a voltage of a cathode electrode of the light emitting element. In general, since the voltage of the cathode electrode is fixed to a constant voltage, a luminance of the light emitting element may be determined based on the voltage of the anode electrode.

In order to maintain a consistency in which the luminance of the light emitting element has a same value for a same grayscale, the voltage of the anode electrode should maintain exactly a same condition in each of the address-scan period and the self-scan period. The display quality may be guaranteed only when the same condition is maintained. For this purpose, the anode initialization operation may be important.

The above information disclosed in this Background section is only for enhancement of understanding of the background and therefore the information discussed in this Background section does not necessarily constitute prior art.

### SUMMARY

Aspects of some embodiments of the present disclosure relates to a pixel, a display device including the pixel, and an electronic device including the display device. For example, aspects of some embodiments of the present disclosure relate to a pixel, a display device including the pixel, and an electronic device including the display device for relatively improving a display quality.

Aspects of some embodiments of the present disclosure include a pixel for performing an anode initialization operation to maintain a same condition in each of an address-scan period and a self-scan period.

Aspects of some embodiments of the present disclosure include a display device including the pixel.

Aspects of some embodiments of the present disclosure include an electronic device including the display device.

According to some embodiments of the present disclosure, a pixel may be driven based on a frame period including an address-scan period and a self-scan period. The pixel comprises a data write transistor configured to output a data voltage in response to a data write gate signal, a driving transistor configured to generate a driving current based on the data voltage, a light emitting element including an anode electrode to which the driving current is applied, and a cathode electrode, a data initialization transistor configured to apply a data initialization voltage to the driving transistor in response to a data initialization gate signal, and an anode initialization transistor configured to apply an anode initialization voltage to the anode in response to an anode initialization gate signal. Each of the address-scan period and the self-scan period includes a non-emission period in which the light emitting element does not emit a light and an emission period in which the light emitting element emits the light, and the non-emission period includes a data initialization period and an anode initialization period following the data initialization period. A voltage of the anode electrode is initialized to the data initialization voltage in the address-scan period and is initialized to the anode initialization voltage in the self-scan period.

According to some embodiments, the driving transistor may be a PMOS transistor.

According to some embodiments, as a difference between the voltage of the anode electrode and the anode initialization voltage is below a threshold, a current which flows from the anode electrode to an anode initialization voltage line which transmits the anode initialization voltage may decrease.

According to some embodiments, the data initialization voltage may be greater than the anode initialization voltage.

According to some embodiments, a difference between the data initialization voltage and the anode initialization voltage may be less than a difference between a voltage of an anode electrode in the emission period and the anode initialization voltage.

According to some embodiments, the address-scan period may further include a data write period between the data initialization period and the anode initialization period. In the data write period, the data write transistor may be configured to apply the data voltage to the driving transistor in response to the data write gate signal.

According to some embodiments, the pixel may further comprise an emission transistor configured to connect the data initialization transistor and the anode electrode in response to an emission signal. The emission transistor may be turned on to connect the data initialization transistor and the anode electrode in the data initialization period, and may be turned off to separate the data initialization transistor and the anode electrode in the anode initialization period.

According to some embodiments, the driving transistor may include a gate electrode connected to a first node, a first electrode connected to a second node, and a second electrode connected to a third node, the data write transistor may include a gate electrode to which the data write gate signal is applied, a first electrode connected to a data line which transmits the data voltage, and a second electrode connected to the second node, the data initialization transistor may include a gate electrode to which the data initialization gate signal is applied, a first electrode to which the data initialization voltage is applied, and a second electrode connected to the third node, the emission transistor may include a gate electrode to which the emission signal is applied, a first electrode connected to the third node, and a second electrode connected to a fourth node, the anode initialization transistor may include a gate electrode to which the anode initialization gate signal is applied, a first electrode to which the anode initialization voltage is applied, and a second electrode connected to the fourth node, and the light emitting element may include the anode electrode connected to the fourth node and the cathode to which a low power supply voltage is applied.

According to some embodiments, the pixel may further comprise a compensation transistor configured to diode-connect the driving transistor in response to a compensation gate signal, a second emission transistor configured to connect a high power supply voltage line which transmits a high power supply voltage and the first electrode of the driving transistor in response to a second emission signal, a bias transistor configured to apply a bias voltage to the first electrode of the driving transistor in response to the anode initialization gate signal, and a storage capacitor configured to store the data voltage. The compensation transistor may include a gate electrode to which the compensation gate signal is applied, a first electrode connected to the first node, and a second electrode connected to the third node, the second emission transistor may include a gate electrode to which the second emission signal is applied, a first electrode to which the high power supply voltage is applied, and a second electrode connected to the second node, the bias transistor may include a gate electrode to which the anode initialization gate signal is applied, a first electrode to which the bias voltage is applied, and a second electrode connected to the second node, and the storage capacitor may include a first electrode to which the high power supply voltage is applied and a second electrode connected to the first node.

According to some embodiments, the driving transistor may include a gate electrode connected to a first node, a first electrode connected to a second node, and a second electrode connected to a third node, the data write transistor may include a gate electrode to which the data write gate signal is applied, a first electrode connected to a data line which transmits the data voltage, and a second electrode connected to a fourth node, the data initialization transistor may include a gate electrode to which the data initialization gate signal is applied, a first electrode to which the data initialization voltage is applied, and a second electrode connected to the third node, the anode initialization transistor may include a gate electrode to which the anode initialization gate signal is applied, a first electrode to which the anode initialization voltage is applied, and a second electrode connected to a fifth node, the emission transistor may include a gate electrode to which the emission signal is applied, a first electrode connected to the third node, and a second electrode connected to the fifth node, and the light emitting element may include the anode electrode connected to the fifth node and the cathode electrode to which a low power supply voltage is applied.

According to some embodiments, the pixel may further comprise a compensation transistor configured to diode-connect the driving transistor in response to a compensation gate signal, a second emission transistor configured to connect a high power supply voltage line which transmits a high power supply voltage and the first electrode of the driving transistor in response to a second emission signal, a bias transistor applying a bias voltage to the first electrode of the driving transistor in response to the anode initialization gate signal, a second compensation transistor configured to connect the high power supply voltage line and the second electrode of the data write transistor in response to the compensation gate signal, a storage capacitor configured to store the data voltage, and a boost capacitor configured to boost a voltage of the first node. The compensation transistor may include a gate electrode to which the compensation gate signal is applied, a first electrode connected to the first node, and a second electrode connected to the third node, the second emission transistor may include a gate electrode to which the second emission signal is applied, a first electrode to which the high power supply voltage is applied, and a second electrode connected to the second node, the bias transistor may include a gate electrode to which the anode initialization gate signal is applied, a first electrode to which the bias voltage is applied, and a second electrode connected to the second node, the storage capacitor may include a first electrode to which the high power supply voltage is applied and a second electrode connected to the fourth node, and the boost capacitor may include a first electrode connected to the fourth node and a second electrode connected to the first node.

According to some embodiments, the pixel may further comprise a first emission transistor configured to connect a high power supply voltage line which transmits a high power supply voltage and a first electrode of the driving transistor in response to an emission signal, and a second emission transistor configured to connect the data initialization transistor and the anode electrode in response to the emission signal. The driving transistor may include a gate electrode connected to a first node, the first electrode connected to a second node, and a second electrode connected to a third node, the data write transistor may include a gate electrode to which the data write gate signal is applied, a first electrode connected to a data line which transmits the data voltage, and a second electrode connected to the second node, the data initialization transistor may include a gate electrode to which the data initialization gate signal is applied, a first electrode to which the data initialization voltage is applied, and a second electrode connected to the third node, the first emission transistor may include a gate electrode to which the emission signal is applied, a first electrode to which the high power supply voltage is applied, and a second electrode connected to the second node, the second emission transistor may include a gate electrode to which the emission signal is applied, a first electrode connected to the third node, and a second electrode connected to a fourth node, the anode initialization transistor may include a gate electrode to which the anode initialization gate signal is applied, a first electrode to which the anode initialization voltage is applied, and a second electrode connected to the fourth node, and the light emitting element may include the anode electrode connected to the fourth node and the cathode electrode to which a low power supply voltage is applied.

According to some embodiments, the pixel may further comprise a compensation transistor configured to diode-connect the driving transistor in response to a compensation gate signal, a bias transistor configured to apply a bias voltage to the first electrode of the driving transistor in response to the anode initialization gate signal, a second data initialization transistor configured to apply the data initialization voltage to the anode electrode in response to the data initialization gate signal, and a storage capacitor configured to store the data voltage. The compensation transistor may include a gate electrode to which the compensation gate signal is applied, a first electrode connected to the first node, and a second electrode connected to the third node, the bias transistor may include a gate electrode to which the anode initialization gate signal is applied, a first electrode to which the bias voltage is applied, and a second electrode connected to the second node, and the second data initialization transistor may include a gate electrode to which the data initialization gate signal is applied, a first electrode to which the data initialization voltage is applied, and a second electrode connected to the fourth node.

In a display device according to some embodiments the present disclosure, the display device comprises a display panel including a pixel driven based on a frame period including an address-scan period and a self-scan period, and a display panel driver configured to drive the display panel. The pixel comprises a data write transistor configured to output a data voltage in response to a data write gate signal, a driving transistor configured to generate a driving current based on the data voltage, a light emitting element including an anode electrode to which the driving current is applied, and a cathode electrode, a data initialization transistor configured to apply a data initialization voltage to the driving transistor in response to a data initialization gate signal, and an anode initialization transistor configured to apply an anode initialization voltage to the anode in response to an anode initialization gate signal. Each of the address-scan period and the self-scan period includes a non-emission period in which the light emitting element does not emit a light and an emission period in which the light emitting element emits the light, and the non-emission period includes a data initialization period and an anode initialization period following the data initialization period. A voltage of the anode electrode is initialized to the data initialization voltage in the address-scan period and is initialized to the anode initialization voltage in the self-scan period.

According to some embodiments, the driving transistor may be a PMOS transistor.

According to some embodiments, as a difference between the voltage of the anode electrode and the anode initialization voltage is below a threshold, a current which flows from the anode electrode to an anode initialization voltage line which transmits the anode initialization voltage may decrease.

According to some embodiments, the data initialization voltage may be greater than the anode initialization voltage.

According to some embodiments, a difference between the data initialization voltage and the anode initialization voltage may be less than a difference between a voltage of an anode electrode in the emission period and the anode initialization voltage.

According to some embodiments, the address-scan period may further include a data write period between the data initialization period and the anode initialization period. In the data write period, the data write transistor may be configured to apply the data voltage to the driving transistor in response to the data write gate signal.

In an electronic device according to some embodiments of the present disclosure, the electronic device comprises a display panel including a pixel driven based on a frame period including an address-scan period and a self-scan period, a display panel driver configured to drive the display panel, and a power supply configured to supply a power to the display panel and the display panel driver. The pixel comprises a data write transistor configured to output a data voltage in response to a data write gate signal, a driving transistor configured to generate a driving current based on the data voltage, a light emitting element including an anode electrode to which the driving current is applied, and a cathode electrode, a data initialization transistor configured to apply a data initialization voltage to the driving transistor in response to a data initialization gate signal, and an anode initialization transistor configured to apply an anode initialization voltage to the anode in response to an anode initialization gate signal. Each of the address-scan period and the self-scan period includes a non-emission period in which the light emitting element does not emit a light and an emission period in which the light emitting element emits the light, and the non-emission period includes a data initialization period and an anode initialization period following the data initialization period. A voltage of the anode electrode is initialized to the data initialization voltage in the address-scan period and is initialized to the anode initialization voltage in the self-scan period.

According to the pixel, the display device, and the electronic device, each of the address-scan period and the self-scan period may include the data initialization period and an anode initialization period, and the voltage of the anode electrode may be initialized in the data initialization period and the anode initialization period. That is, the voltage of the anode electrode may be initialized multiple times, and the voltage of the anode electrode may be maintained consistently. Accordingly, a display quality may be guaranteed or relatively improved.

### BRIEF DESCRIPTION OF THE DRAWINGS

The above and other features of embodiments of the present disclosure will become more apparent by describing in detailed embodiments thereof with reference to the accompanying drawings, in which:

FIG. 1 is a block diagram showing a display device according to some embodiments of the present disclosure;

FIG. 2 is a circuit diagram showing an example of a pixel of FIG. 1;

FIG. 3 is a timing diagram showing an example of driving a pixel of FIG. 2;

FIG. 4 is a timing diagram showing an example of driving a pixel of FIG. 2 in a data initialization period of FIG. 3;

FIG. 5 is a timing diagram showing an example of driving a pixel of FIG. 2 in a data write compensation period of FIG. 3;

FIG. 6 is a timing diagram showing an example of driving a pixel of FIG. 2 in an anode initialization period of FIG. 3;

FIG. 7 is a timing diagram showing an example of driving a pixel of FIG. 2 in an emission period of FIG. 3;

FIG. 8 is a circuit diagram showing an anode current flowing in a pixel of FIG. 2 in an anode initialization period of FIG. 3;

FIG. 9 is a graph showing a voltage of an anode electrode according to an anode initialization operation in a data initialization period and an anode initialization period of FIG. 3;

FIG. 10 is a conceptual diagram showing a driving frequency of a display panel of FIG. 1;

FIG. 11 is a timing diagram showing a signal of a pixel of FIG. 2 when an emission frequency is 480 Hz;

FIG. 12 is a timing diagram showing a signal of a pixel of FIG. 2 when an emission frequency is 240 Hz;

FIG. 13 is a circuit diagram showing an example of a pixel of FIG. 1;

FIG. 14 is a timing diagram showing an example of driving a pixel of FIG. 13;

FIG. 15 is a circuit diagram showing an example of a pixel of FIG. 1;

FIG. 16 is a block diagram showing an electronic device; and

FIG. 17 is a diagram showing embodiments in which an electronic device of FIG. 16 is implemented as a smart phone.

### DETAILED DESCRIPTION

Hereinafter, aspects of some embodiments of the present disclosure will be described in more detail with reference to the accompanying drawings.

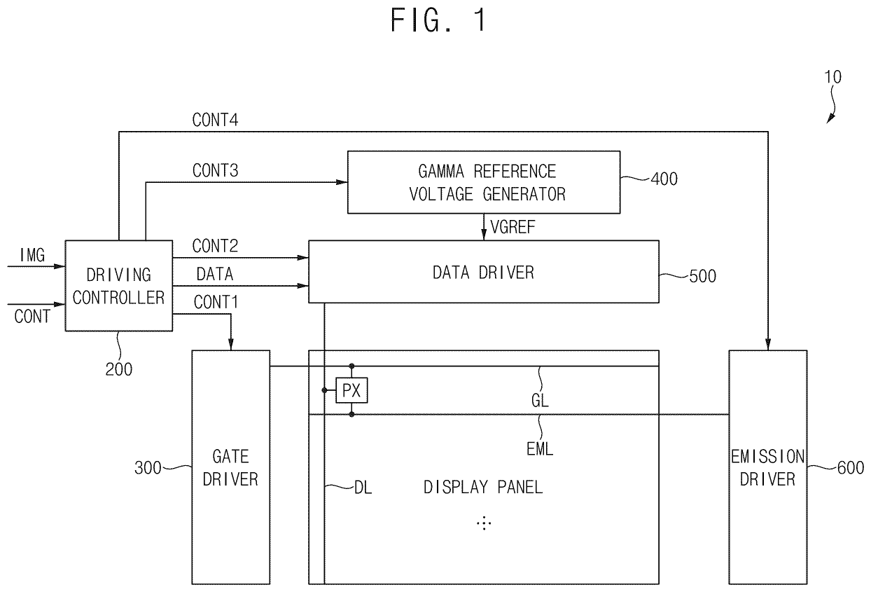

FIG. 1 is a block diagram showing a display device 10 according to some embodiments of the present disclosure.

Referring to FIG. 1, a display device 10 may include a display panel 100 and a display panel driver. The display panel driver may include a driving controller 200, a gate driver 300, a gamma reference voltage generator 400, a data driver 500, and an emission driver 600.

The display panel 100 may include a display area for displaying an image and a peripheral area located adjacent to the display area.

The display panel 100 may include gate lines GL, data lines DL, emission lines EML, and pixels PX electrically connected to the gate lines GL, the data lines DL, and the emission lines EML, respectively. The gate lines GL may extend in a first direction, the data lines DL may extend in a second direction crossing the first direction, and the emission lines EML may extend in the first direction.

The driving controller 200 may receive input image data IMG and an input control signal CONT from an external device. For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The gate driver 300 may generate gate signals for driving the gate lines GL in response to the first control signal CONT1 received from the driving controller 200. The gate driver 300 may output the gate signals to the gate lines GL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

For example, the gamma reference voltage generator 400 may be located within the driving controller 200 or may be located within the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

The emission driver 600 may generate emission signals for driving the emission lines EML in response to the fourth control signal CONT4 received from the driving controller 200. The emission driver 600 may output the emission signals to the emission lines EML.

In FIG. 1, for a convenience of an explanation, the gate driver 300 may be located on a first side of the display panel 100 and the emission driver 600 may be located on a second side of the display panel 100. Although shown, the present disclosure is not limited thereto. For example, both the gate driver 300 and the emission driver 600 may be located on the first side of the display panel 100. For example, both the gate driver 300 and the emission driver 600 may be located on both sides of the display panel 100. For example, the gate driver 300 and the emission driver 600 may be formed integrally.

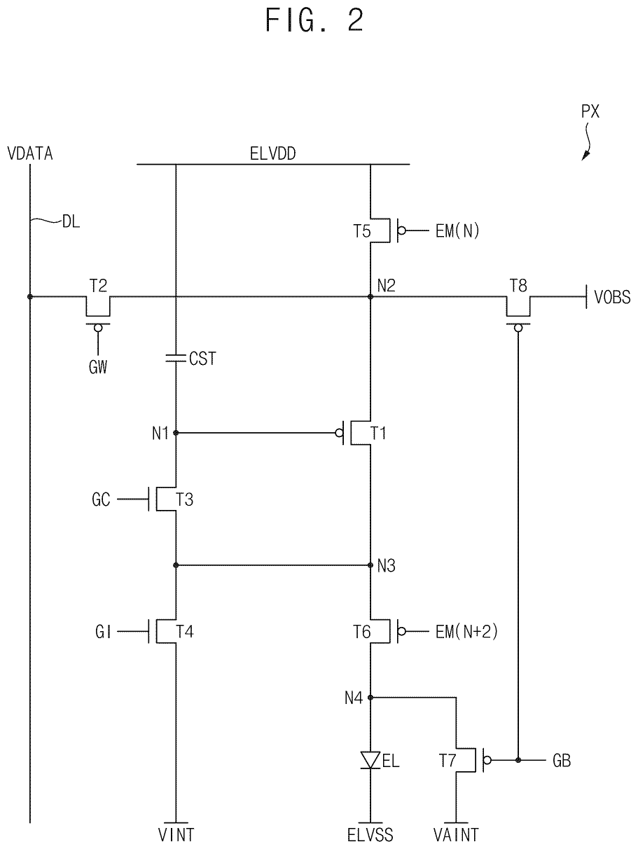

FIG. 2 is a circuit diagram showing an example of a pixel PX of FIG. 1. Although FIG. 2 illustrates various components in a pixel according to some embodiments, embodiments according to the present disclosure are not limited thereto, and according to various embodiments, the pixel may include additional components or fewer components without departing from the spirit and scope of embodiments according to the present disclosure.

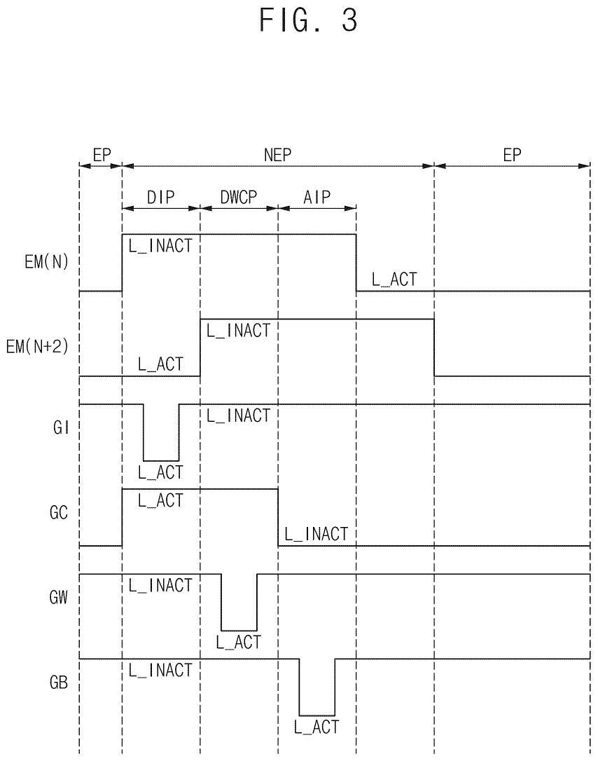

FIG. 3 is a timing diagram showing an example of driving a pixel PX of FIG. 2.

Referring to FIGS. 1 to 3, the display panel 100 may include pixels PX. Each of the pixels PX may include first to eighth transistors T1 to T8, a storage capacitor CST, and a light emitting element EL. However, the present disclosure is not limited to the pixel PX of FIG. 2. The present disclosure may be applied to various embodiments.

The first transistor T1 may include a gate electrode connected to a first node N1, a first electrode connected to a second node N2, and a second electrode connected to a third node N3. According to some embodiments, the first transistor T1 may be a PMOS transistor. The first transistor T1 may generate a driving current based on a voltage of the first node N1 and a voltage of the second node N2. The first transistor T1 may be referred to as a driving transistor.

The second transistor T2 may include a gate electrode to which a data write gate signal GW is applied, a first electrode connected to a data line DL which transmits a data voltage VDATA, and a second electrode connected to the second node N2. According to some embodiments, the second transistor T2 may be the PMOS transistor. The second transistor T2 may apply the data voltage VDATA to the second node N2 in response to the data write gate signal GW. The second transistor T2 may be referred to as a data write transistor.

The third transistor T3 may include a gate electrode to which a compensation gate signal GC is applied, a first electrode connected to the first node N1, and a second electrode connected to the third node N3. According to some embodiments, the third transistor T3 may be an NMOS transistor. The third transistor T3 may diode-connect the first transistor T1 in response to the compensation gate signal GC. The third transistor T3 may be referred to as a compensation transistor.

The fourth transistor T4 may include a gate electrode to which a data initialization gate signal GI is applied, a first electrode to which a data initialization voltage VINT is applied, and a second electrode connected to the third node N3. According to some embodiments, the fourth transistor T4 may be the PMOS transistor. The fourth transistor T4 may apply the data initialization voltage VINT to the first transistor T1 in response to the data initialization gate signal GI. The fourth transistor T4 may be referred to as a data initialization transistor.

The fifth transistor T5 may include a gate electrode to which an emission signal EM(N) is applied, a first electrode to which a high power supply voltage ELVDD is applied, and a second electrode connected to the second node N2. According to some embodiments, the fifth transistor T5 may be the PMOS transistor. The fifth transistor T5 may connect a high power supply voltage line which transmits the high power supply voltage ELVDD and the second node N2 in response to the emission signal EM(N). The fifth transistor T5 may be referred to as a first emission transistor.

The sixth transistor T6 may include a gate electrode to which a next emission signal EM(N+2) is applied, a first electrode connected to the third node N3, and a second electrode connected to a fourth node N4. According to some embodiments, the sixth transistor T6 may be the PMOS transistor. The sixth transistor T6 may connect the third node N3 and the fourth node N4 in response to the next emission signal EM(N+2). The sixth transistor T6 may be referred to as a second emission transistor.

The emission signal EM(N) may be an N-th emission signal, and the next emission signal EM(N+2) may be an N+2-th emission signal. Here, N may be a positive integer greater than or equal to 1. However, in a pixel PX of FIG. 2, the next emission signal is not limited to the N+2-th emission signal. For example, the next emission signal may be an N+1-th emission signal.

The seventh transistor T7 may include a gate electrode to which an anode initialization gate signal GB is applied, a first electrode to which an anode initialization voltage VAINT is applied, and a second electrode connected to the fourth node N4. According to some embodiments, the seventh transistor T7 may be the PMOS transistor. The seventh transistor T7 may apply the anode initialization voltage VAINT to the fourth node N4 in response to the anode initialization gate signal GB. According to some embodiments, the data initialization voltage VINT may be greater than the anode initialization voltage VAINT. The seventh transistor T7 may be referred to as an anode initialization transistor.

The eighth transistor T8 may include a gate electrode to which the anode initialization gate signal GB is applied, a first electrode to which a bias voltage VOBS is applied, and a second electrode connected to the second node N2. According to some embodiments, the eighth transistor T8 may be the PMOS transistor. The eighth transistor T8 may apply the bias voltage VOBS to the second node N2 in response to the anode initialization gate signal GB. The eighth transistor T8 may be referred to as a bias transistor.

The storage capacitor CST may include a first electrode to which the high power supply voltage ELVDD is applied and a second electrode connected to the first node N1. The storage capacitor CST may store the data voltage VDATA.

The light emitting element EL may include an anode electrode connected to the fourth node N4 and a cathode electrode to which a low power supply voltage ELVSS is applied. The driving current may be applied to the anode electrode, a voltage of the anode electrode may be determined based on the driving current, and a luminance of the light emitting element EL may be determined based on the voltage of the anode electrode.

A frame period for the pixel PX may include a non-emission period NEP and an emission period EP. The non-emission period NEP may be a period in which the light emitting element EL does not emit the light, and the emission period EP may be a period in which the light emitting element EL emits the light.

The non-emission period NEP may include a data initialization period DIP, a data write compensation period DWCP following the data initialization period DIP, and an anode initialization period AIP following the data write compensation period DWCP. Here, a signal EM(N), EM(N+2), GI, GC, GW, GB applied to the pixel PX may have an active level L_ACT and an inactive level L_INACT. The active level L_ACT is a level which turns on a transistor when the signal EM(N), EM(N+2), GI, GC, GW, GB is applied to a gate electrode of the transistor. The inactive level L_INACT is a level which turns off the transistor when the signal EM(N), EM(N+2), GI, GC, GW, GB is applied to the gate electrode of the transistor.

In the data initialization period DIP, the emission signal EM(N) may have the inactive level L_INACT, the next emission signal EM(N+2) may have the active level L_ACT, the data initialization gate signal GI may have the active level L_ACT, the compensation gate signal GC may have the active level L_ACT, the data write gate signal GW may have the inactive level L_INACT, and the anode initialization gate signal GB may have the inactive level L_INACT.

In the data write compensation period DWCP, the emission signal EM(N) may have the inactive level L_INACT, the next emission signal EM(N+2) may have the inactive level L_INACT, the data initialization gate signal GI may have the inactive level L_INACT, the compensation gate signal GC may have the active level L_ACT, the data write gate signal GW may have the active level L_ACT, and the anode initialization gate signal GB may have the inactive level L_INACT.

In the anode initialization period AIP, the emission signal EM(N) may have the inactive level L_INACT, the next emission signal EM(N+2) may have the inactive level L_INACT, the data initialization gate signal GI may have the inactive level L_INACT, the compensation gate signal GC may have the inactive level L_INACT, the data write gate signal GW may have the inactive level L_INACT, and the anode initialization gate signal GB may have the active level L_ACT.

In the emission period EP, the emission signal EM(N) may have the active level L_ACT, the next emission signal EM(N+2) may have the active level L_ACT, the data initialization gate signal GI may have the inactive level L_INACT, the compensation gate signal GC may have the inactive level L_INACT, the data write gate signal GW may have the inactive level L_INACT, and the anode initialization gate signal GB may have the inactive level L_INACT.

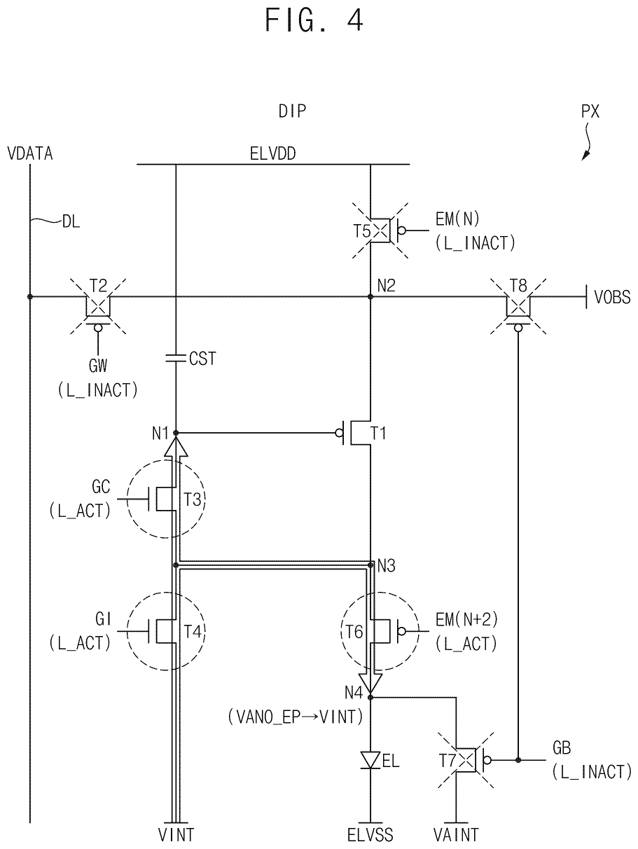

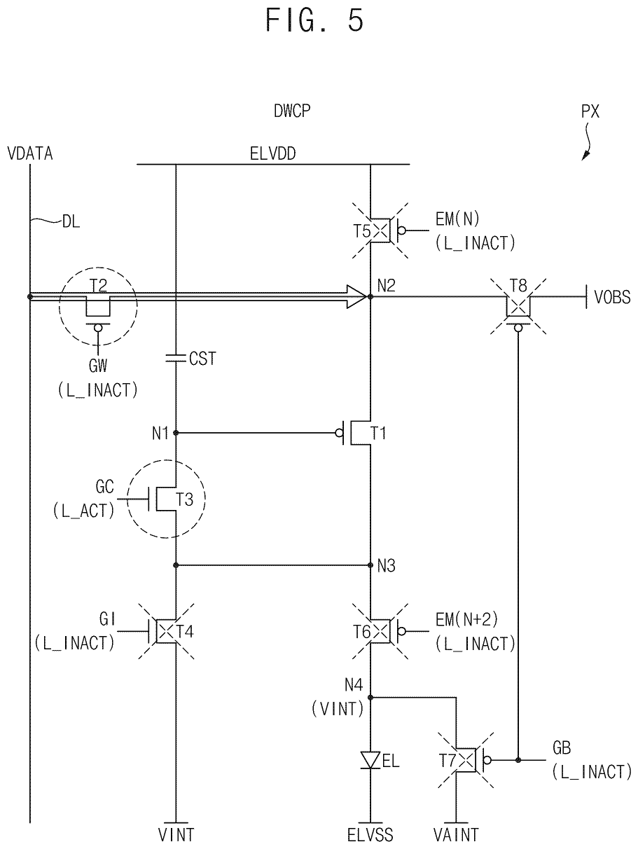

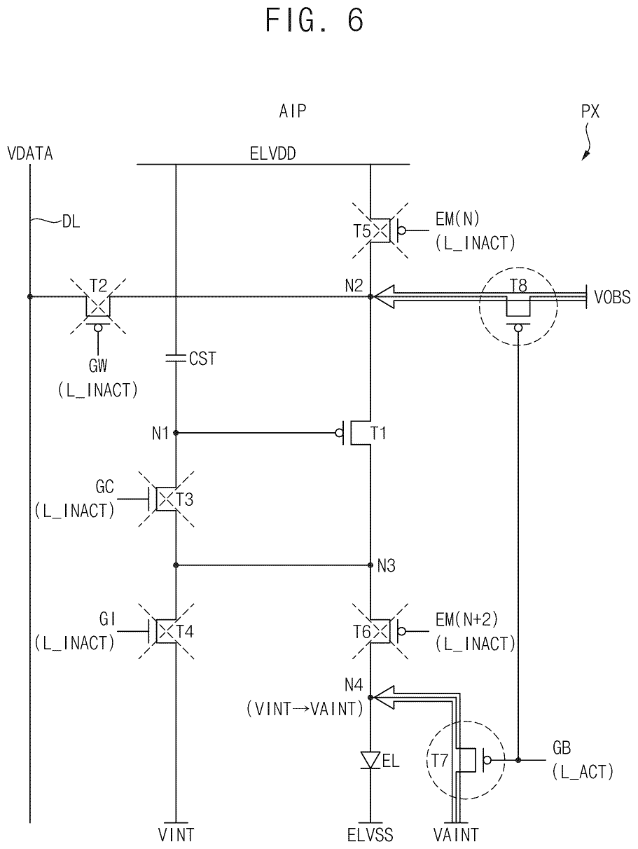

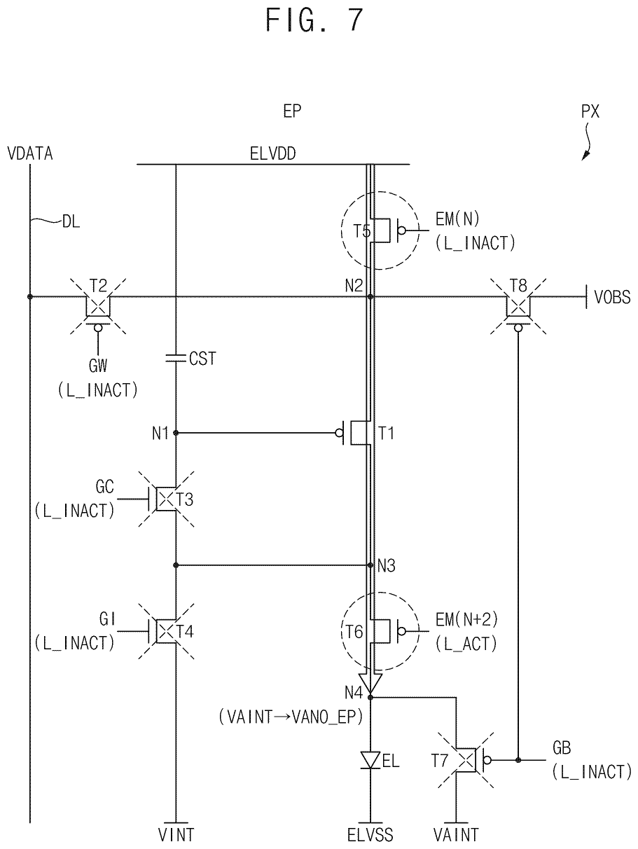

FIG. 4 is a timing diagram showing an example of driving a pixel PX of FIG. 2 in a data initialization period DIP of FIG. 3. FIG. 5 is a timing diagram showing an example of driving a pixel PX of FIG. 2 in a data write compensation period DWCP of FIG. 3. FIG. 6 is a timing diagram showing an example of driving a pixel PX of FIG. 2 in an anode initialization period AIP of FIG. 3. FIG. 7 is a timing diagram showing an example of driving a pixel PX of FIG. 2 in an emission period EP of FIG. 3.

Referring to FIGS. 3 and 4, in the data initialization period DIP, the second transistor T2 may be turned off in response to the data write gate signal GW having the inactive level L_INACT, the fifth transistor T5 may be turned off in response to the emission signal EM(N) having the inactive level L_INACT, the seventh transistor T7 may be turned off in response to the anode initialization gate signal GB having the inactive level L_INACT, and the eighth transistor T8 may be turned off in response to the anode initialization gate signal GB having the inactive level L_INACT.

The fourth transistor T4 may be turned on in response to the data initialization gate signal GI having the active level L_ACT to apply the data initialization voltage VINT to the third node N3. Therefore, a voltage of the third node N3 may have the data initialization voltage VINT.

The third transistor T3 may be turned on in response to the compensation gate signal GC having the active level L_ACT to apply the voltage (i.e., the data initialization voltage VINT) of the third node N3 to the first node N1. Therefore, a voltage of the first node N1 may have the data initialization voltage VINT.

The sixth transistor T6 may be turned on in response to the next emission signal EM(N+2) having the active level L_ACT to apply the voltage (i.e., the data initialization voltage VINT) of the third node N3 to the fourth node N4. Therefore, a voltage of the fourth node N4 may be changed from a voltage VANO_EP of an anode electrode in an emission period EP of a previous frame period to the data initialization voltage VINT. That is, the voltage of the anode electrode may be initialized to the data initialization voltage VINT.

As such, in the data initialization period DIP, a data initialization operation for initializing the data voltage VDATA stored in the storage capacitor CST in the previous frame period may be performed, and an anode initialization operation for initializing the voltage of the anode electrode may be performed.

Referring to FIGS. 3 and 5, in the data write compensation period DWCP, the fourth transistor T4 may be turned off in response to the data initialization gate signal GI having the inactive level L_INACT, the fifth transistor T5 may be turned off in response to the emission signal EM(N) having the inactive level L_INACT, the sixth transistor T6 may be turned off in response to the next emission signal EM(N+2) having the inactive level L_INACT, the seventh transistor T7 may be turned off in response to the anode initialization gate signal GB having the inactive level L_INACT, and the eighth transistor T8 may be turned off in response to the anode initialization gate signal GB having the inactive level L_INACT.

The second transistor T2 may be turned on in response to the data write gate signal GW having the active level L_ACT to apply the data voltage VDATA to the second node N2. Therefore, a voltage of the second node N2 may have the data voltage VDATA.

The first transistor T1 may be turned on in response to the voltage (i.e., the data initialization voltage VINT) of the first node N1 and the voltage (i.e., the data voltage VDATA) of the second node N2 to apply the voltage of the second node N2 to the third node N3. The third transistor T3 may be turned on in response to the compensation gate signal GC having the active level L_ACT to diode-connect the first transistor T1. Therefore, a threshold voltage of the first transistor T1 may be compensated, and the storage capacitor CST may store the data voltage VDATA for which the threshold voltage of the first transistor T1 is compensated.

As such, in the data write compensation period DWCP, a data write operation for applying the data voltage VDATA to the pixel PX and a compensation operation for compensating the threshold voltage of the first transistor T1 may be performed.

Referring to FIG. 3 and FIG. 6, in the anode initialization period AIP, the second transistor T2 may be turned off in response to the data write gate signal GW having the inactive level L_INACT, the third transistor T3 may be turned off in response to the compensation gate signal GC having the inactive level L_INACT, the fourth transistor T4 may be turned off in response to the data initialization gate signal GI having the inactive level L_INACT, the fifth transistor T5 may be turned off in response to the emission signal EM(N) having the inactive level L_INACT, and the sixth transistor T6 may be turned off in response to the next emission signal EM(N+2) having the inactive level L_INACT.

The seventh transistor T7 may be turned on in response to the anode initialization gate signal GI having the active level L_ACT to apply the anode initialization voltage VAINT to the fourth node N4. Therefore, a voltage of the fourth node N4 may be changed from the data initialization voltage VINT to the anode initialization voltage VAINT. That is, the voltage of the anode electrode may be initialized to the anode initialization voltage VAINT. In this case, since the sixth transistor T6 is turned off, the sixth transistor T6 may separate the fourth transistor T4 and the fourth node N4, and the anode initialization voltage VAINT may not be applied to the third node N3 and may not affect the voltage of the third node N3.

The eighth transistor T8 may be turned on in response to the anode initialization gate signal GI having the active level L_ACT to apply the bias voltage VOBS to the second node N2. Therefore, a hysteresis characteristic of the first transistor T1 may be relatively improved.

As such, the anode initialization operation may be performed in the anode initialization period AIP.

Referring to FIG. 3 and FIG. 7, in the emission period EP, the second transistor T2 may be turned off in response to the data write gate signal GW having the inactive level L_INACT, the third transistor T3 may be turned off in response to the compensation gate signal GC having the inactive level L_INACT, the fourth transistor T4 may be turned off in response to the data initialization gate signal GI having the inactive level L_INACT, the seventh transistor T7 may be turned off in response to the anode initialization gate signal GB having the inactive level L_INACT, and the eighth transistor T8 may be turned off in response to the anode initialization gate signal GB having the inactive level L_INACT.

The fifth transistor T5 may be turned on in response to the emission signal EM(N) having the active level L_ACT to connect the high power supply voltage line and the second node N2, and the sixth transistor T6 may be turned on in response to the next emission signal EM(N+2) having the active level L_ACT to connect the third node N3 and the fourth node N4.

The first transistor T1 may generate the driving current based on the voltage of the first node N1 and the voltage of the second node N2. The driving current may be applied to the anode electrode along a path of the fifth transistor T5, the first transistor T1, and the sixth transistor T6. Therefore, the voltage of the fourth node N4 may be changed from the anode initialization voltage VAINT to a voltage VANO_EP of the anode electrode in the emission period EP.

The light emitting element EL may emit the light based on the voltage VANO_EP of the anode electrode.

As such, in the emission period EP, a emission operation in which the light emitting element EL emits the light may be performed.

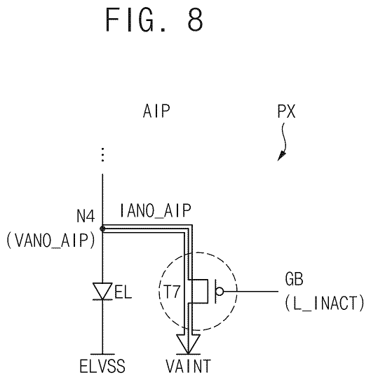

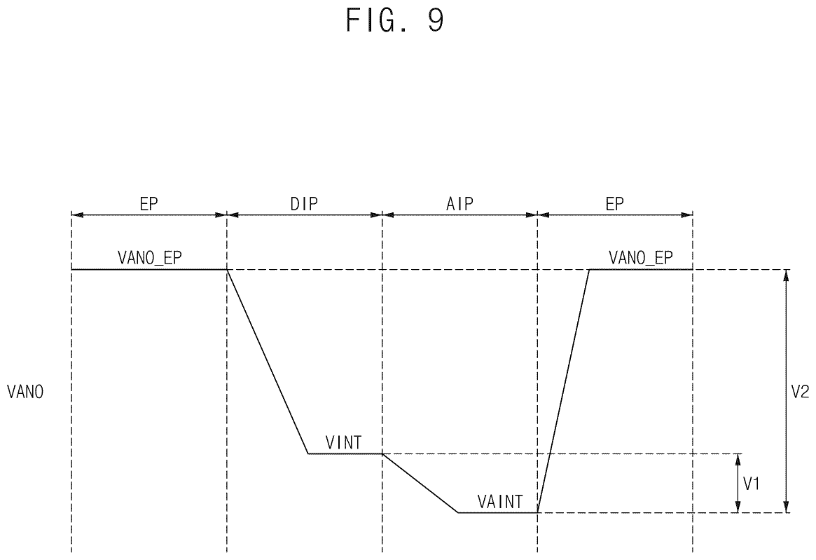

FIG. 8 is a circuit diagram showing an anode current IANO_AIP flowing in a pixel PX of FIG. 2 in an anode initialization period AIP of FIG. 3. FIG. 9 is a graph showing a voltage VANO of an anode electrode according to an anode initialization operation in a data initialization period DIP and an anode initialization period AIP of FIG. 3.

Referring to FIGS. 1 to 9, the anode initialization operation may be performed not only in the anode initialization period AIP but also in the data initialization period DIP.

In the data initialization period DIP, the fourth transistor T4 may apply the data initialization voltage VINT to the anode electrode in response to the data initialization gate signal GI having the active level L_ACT. Therefore, the voltage VANO of the anode electrode may be changed from the voltage VANO_EP of the anode electrode in the emission period EP of the previous frame period to the data initialization voltage VINT. That is, the voltage of the anode electrode may be initialized to the data initialization voltage VINT.

In the anode initialization period AIP, the seventh transistor T7 may apply the anode initialization voltage VAINT to the anode electrode in response to the anode initialization gate signal GB having the active level L_ACT. Therefore, the voltage VANO of the anode electrode may be changed from the data initialization voltage VINT to the anode initialization voltage VAINT. That is, the voltage of the anode electrode may be initialized to the anode initialization voltage VAINT.

As such, the voltage VANO of the anode electrode may be initialized multiple times.

In the anode initialization period AIP, as a difference between the voltage VANO_AIP of the anode electrode and the anode initialization voltage VAINT is small (e.g., below a threshold, or a set or predetermined threshold value), a drain-source voltage of the seventh transistor T7 (e.g., the anode initialization transistor may decrease, and accordingly, an anode current IANO_AIP, which is a current flowing from the anode electrode to an anode initialization voltage line which transmits the anode initialization voltage VAINT, may decrease. In the anode initialization period AIP, as the anode current IANO_AIP is small (e.g., below a threshold, or a set or predetermined threshold value), the voltage VANO of the anode electrode may maintain a consistency to have a constant value.

A difference V1 between the data initialization voltage VINT and the anode initialization voltage VAINT may be less than a difference V2 between the voltage VANO_EP of the anode electrode in the emission period EP and the anode initialization voltage VAINT. Therefore, in the data initialization period DIP, when the anode initialization operation is not performed, the voltage VANO of the anode electrode may be changed from the voltage VANO_EP of the anode electrode in the emission period EP of the previous frame period to the anode initialization voltage VAINT, and the anode current IANO_AIP may be relatively large. Accordingly, the voltage VANO of the anode electrode may not maintain the consistency. In this case, a stain may be recognized on the display panel 100. The stain may be referred to as a mura. In a low grayscale, since the voltage VANO of the anode electrode in the light emission period EP of the previous frame period is relatively small, the mura may be more recognized in the low grayscale.

On the other hand, in the data initialization period DIP, when the anode initialization operation is performed, the voltage VANO of the anode electrode may be changed from the data initialization voltage VINT to the anode initialization voltage VAINT, and the anode current IANO_AIP may be relatively small. Therefore, the voltage VANO of the anode electrode may maintain the consistency.

As such, when the voltage VANO of the anode electrode is initialized multiple times, the voltage VANO of the anode electrode may maintain the consistency, and the display quality may be guaranteed.

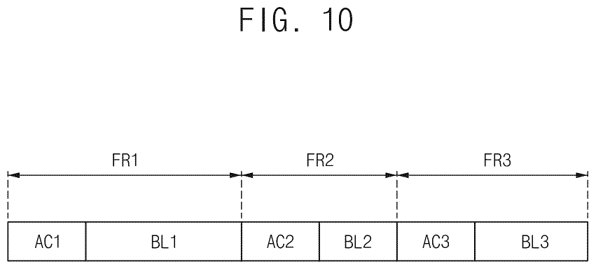

FIG. 10 is a conceptual diagram showing a driving frequency of a display panel 100 of FIG. 1.

Referring to FIGS. 1 to 10, a display panel 100 may be driven with a variable driving frequency. A first frame FR1 having a first driving frequency may include a first active period AC1 and a first blank period BL1. A second frame FR2 having a second driving frequency different from the first driving frequency may include a second active period AC2 and a second blank period BL2. A third frame FR3 having a third driving frequency different from the first and second driving frequencies may include a third active period AC3 and a third blank period BL3.

The first active period AC1 may have a same length as the second active period AC2, and the first blank period BL1 may have a different length from the second blank period BL2.

The second active period AC2 may have a same length as the third active period AC3, and the second blank period BL2 may have a different length from the third blank period BL3.

A frame period for the display panel 100 driven by the variable driving frequency may include an address-scan period in which the data write operation is performed and a self-scan period in which only the emission operation is performed without the data write operation. The address-scan period may be arranged within the active periods AC1, AC2, AC3. The self-scan period may be arranged within the blank periods BL1, BL2, BL3.

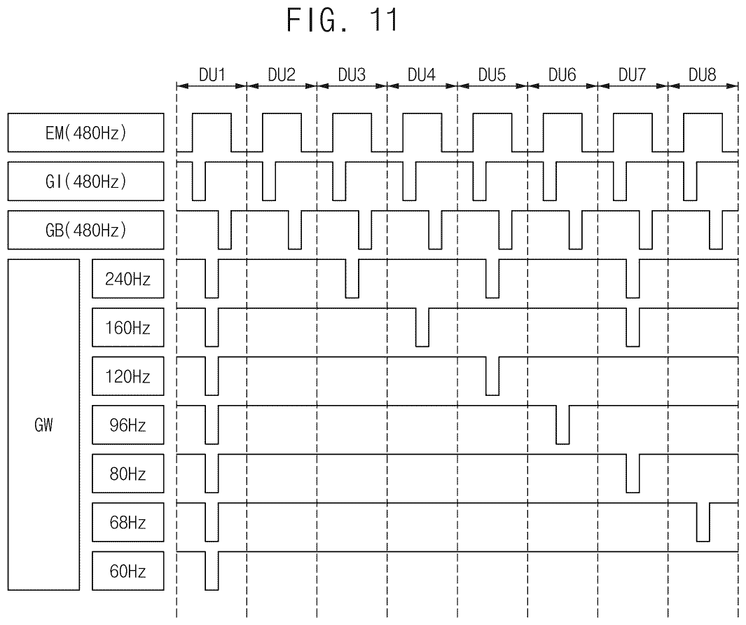

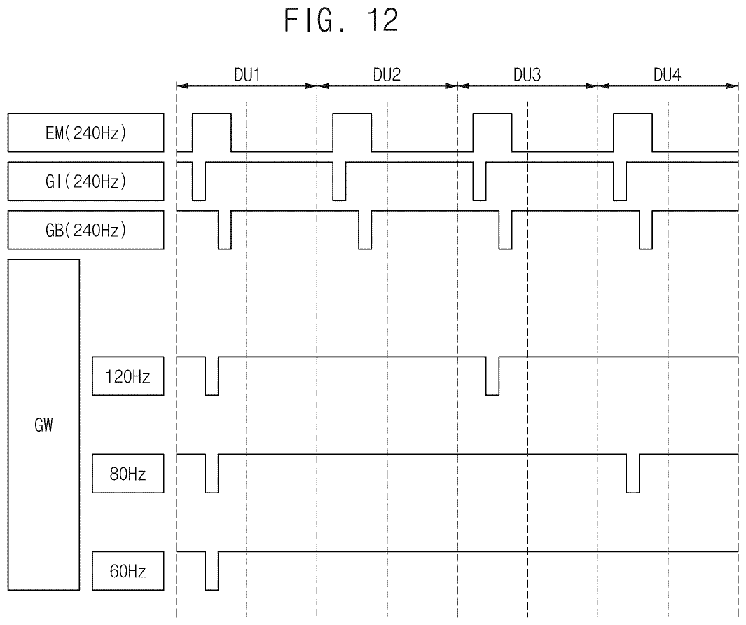

FIG. 11 is a timing diagram showing a signal EM, GI, GB, GW of a pixel PX of FIG. 2 when an emission frequency is 480 Hz. FIG. 12 is a timing diagram showing a signal EM, GI, GB, GW of a pixel PX of FIG. 2 when an emission frequency is 240 Hz.

Referring to FIGS. 1 to 12, the display panel 100 may be driven with the variable driving frequency. According to some embodiments, the display panel 100 driven with the variable driving frequency may be driven in a cycle manner. The cycle manner means that the emission operation is performed in a constant cycle. Therefore, in the display panel 100 driven in the cycle manner, the mura may be recognized according to a frequency of the emission operation.

The frame period for the display panel 100 driven in the cycle manner may include an address-scan period and a self-scan period following the address-scan period. Each of the address-scan period and the self-scan period may include the non-emission period NEP in which the light emitting element EL does not emit the light and the emission period EP in which the light emitting element EL emits the light.

As described above, the address-scan period may be a period in which the data write operation is performed, and the self-scan period may be a period in which the data write operation is not performed and only the emission operation is performed. Therefore, the data initialization operation, the data write operation, and the anode initialization operation may be performed in the non-emission period NEP of the address-scan period, and the data initialization operation and the anode initialization operation may be performed in the non-emission period NEP of the self-scan period.

For example, referring to FIG. 11, the display panel 100 may be driven at a maximum of 240 Hz. When the display panel 100 is driven at a maximum of 240 Hz, the emission operation based on the emission signal EM may be performed at 480 Hz, the anode initialization operation based on the data initialization gate signal GI may be performed at 480 Hz, and the anode initialization operation based on the anode initialization gate signal GB may be performed at 480 Hz.

When the display panel 100 is driven at 240 Hz, the data write gate signal GW may have an active level L_ACT in a first duration DU1, a third duration DU3, a fifth duration DU5, and a seventh duration DU7, and the data write operation may be performed. Therefore, the first duration DU1, the third duration DU3, the fifth duration DU5, and the seventh duration DU7 may be the address-scan period, and the second duration DU2, the fourth duration DU4, the sixth duration DU6, and the eighth duration DU8 may be the self-scan period. Here, when the display panel 100 is driven at 240 Hz and the emission operation is performed at 480 Hz, it may be said that the display panel 100 operates in 2 cycles.

When the display panel 100 is driven at 120 Hz, the data write gate signal GW may have an active level L_ACT in the first duration DU1 and the fifth duration DU5, and the data write operation may be performed. Therefore, the first duration DU1 and the fifth duration DU5 may be the address-scan period, and the second to fourth durations DU2 to DU4 and the sixth to eighth durations DU6 to DU8 may be the self-scan period. Here, when the display panel 100 is driven at 120 Hz and the emission operation is performed at 480 Hz, it may be said that the display panel 100 operates in 4 cycles.

For example, referring to FIG. 12, the display panel 100 may be driven at a maximum of 120 Hz. When the display panel 100 is driven at a maximum of 120 Hz, the emission operation based on the emission signal EM may be performed at 240 Hz, the anode initialization operation based on the data initialization gate signal GI may be performed at 240 Hz, and the anode initialization operation based on the anode initialization gate signal GB may be performed at 240 Hz.

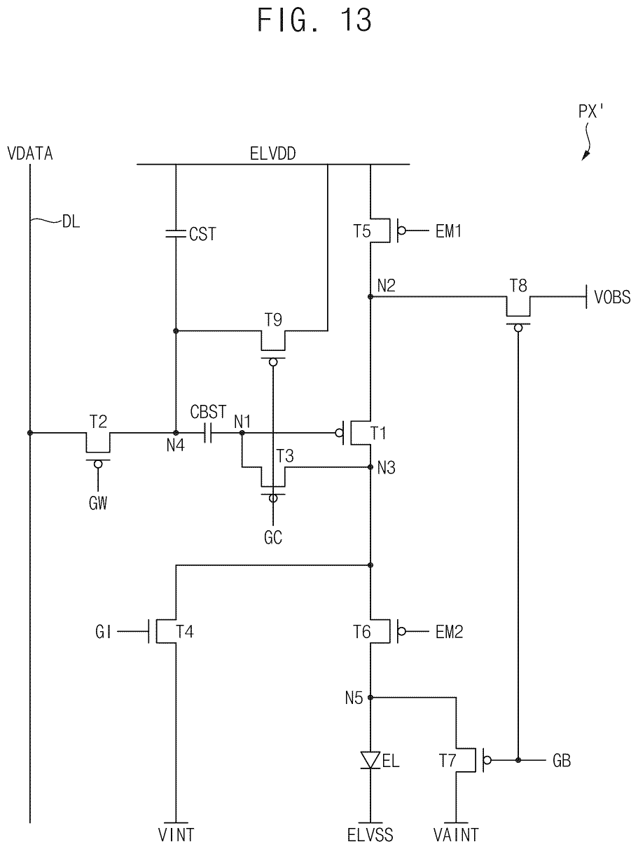

FIG. 13 is a circuit diagram showing an example PX′ of a pixel PX of FIG. 1. Although FIG. 13 illustrates various components in a pixel according to some embodiments, embodiments according to the present disclosure are not limited thereto, and according to various embodiments, the pixel may include additional components or fewer components without departing from the spirit and scope of embodiments according to the present disclosure.

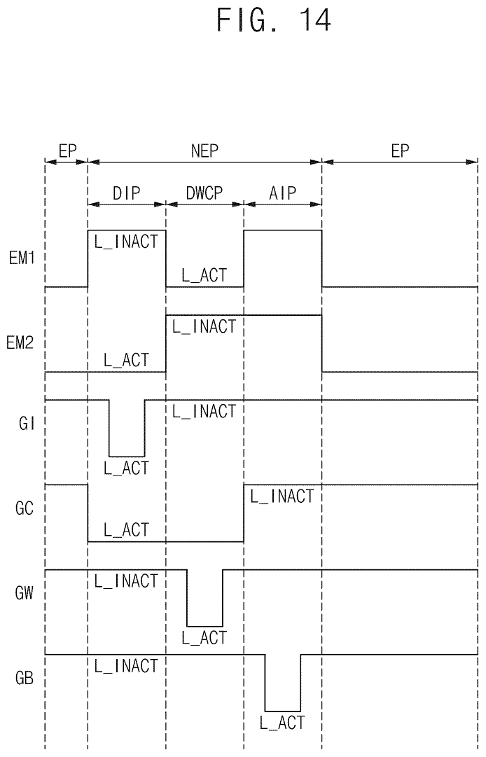

FIG. 14 is a timing diagram showing an example of driving a pixel PX′ of FIG. 13.

Referring to FIGS. 1 to 13, the display panel 100 may include pixels PX′. Each of the pixels PX′ may include first to ninth transistors T1 to T9, a storage capacitor CST, a boost capacitor CBST, and a light emitting element EL. However, the present disclosure is not limited to the pixel PX′ of FIG. 13. The present disclosure may be applied to various embodiments.

The first transistor T1 may include a gate electrode connected to a first node N1, a first electrode connected to a second node N2, and a second electrode connected to a third node N3. According to some embodiments, the first transistor T1 may be a PMOS transistor. The first transistor T1 may generate a driving current based on a voltage of the first node N1 and a voltage of the second node N2. The first transistor T1 may be referred to as a driving transistor.

The second transistor T2 may include a gate electrode to which a data write gate signal GW is applied, a first electrode connected to a data line DL which transmits a data voltage VDATA, and a second electrode connected to a fourth node N4. According to some embodiments, the second transistor T2 may be the PMOS transistor. The second transistor T2 may apply the data voltage VDATA to the fourth node N4 in response to the data write gate signal GW. The second transistor T2 may be referred to as a data write transistor.

The third transistor T3 may include a gate electrode to which a compensation gate signal GC is applied, a first electrode connected to the first node N1, and a second electrode connected to the third node N3. According to some embodiments, the third transistor T3 may be the PMOS transistor. The third transistor T3 may diode-connect the first transistor T1 in response to the compensation gate signal GC. The third transistor T3 may be referred to as a compensation transistor.

The fourth transistor T4 may include a gate electrode to which a data initialization gate signal GI is applied, a first electrode to which a data initialization voltage VINT is applied, and a second electrode connected to the third node N3. According to some embodiments, the fourth transistor T4 may be the PMOS transistor. The fourth transistor T4 may apply the data initialization voltage VINT to the first transistor T1 in response to the data initialization gate signal GI. The fourth transistor T4 may be referred to as a data initialization transistor.

The fifth transistor T5 may include a gate electrode to which a first emission signal EM1 is applied, a first electrode to which a high power supply voltage ELVDD is applied, and a second electrode connected to the second node N2. According to some embodiments, the fifth transistor T5 may be the PMOS transistor. The fifth transistor T5 may connect a high power supply voltage line which transmits a high power supply voltage ELVDD and the second node N2 in response to the first emission signal EM1. The fifth transistor T5 may be referred to as a first emission transistor.

The sixth transistor T6 may include a gate electrode to which a second emission signal EM2 is applied, a first electrode connected to the third node N3, and a second electrode connected to a fifth node N5. According to some embodiments, the sixth transistor T6 may be the PMOS transistor. The sixth transistor T6 may connect the third node N3 and the fifth node N5 in response to the second emission signal EM2. The sixth transistor T6 may be referred to as a second emission transistor.

The seventh transistor T7 may include a gate electrode to which an anode initialization gate signal GB is applied, a first electrode to which an anode initialization voltage VAINT is applied, and a second electrode connected to the fifth node N5. According to some embodiments, the seventh transistor T7 may be the PMOS transistor. The seventh transistor T7 may apply the anode initialization voltage VAINT to the fifth node N5 in response to the anode initialization gate signal GB. According to some embodiments, the data initialization voltage VINT may be greater than the anode initialization voltage VAINT. The seventh transistor T7 may be referred to as an anode initialization transistor.

The eighth transistor T8 may include a gate electrode to which the anode initialization gate signal GB is applied, a first electrode to which a bias voltage VOBS is applied, and a second electrode connected to the second node N2. According to some embodiments, the eighth transistor T8 may be the PMOS transistor. The eighth transistor T8 may apply the bias voltage VOBS to the second node N2 in response to the anode initialization gate signal GB. The eighth transistor T8 may be referred to as a bias transistor.

The ninth transistor T9 may include a gate electrode to which the compensation gate signal GC is applied, a first electrode to which the high power supply voltage ELVDD is applied, and a second electrode connected to the fourth node N4. According to some embodiments, the ninth transistor T9 may be the PMOS transistor. The ninth transistor T9 may connect the high power supply voltage line which transmits the high power supply voltage ELVDD and the fourth node N4. The ninth transistor T9 may be referred to as a second compensation transistor.

The storage capacitor CST may include a first electrode to which the high power supply voltage ELVDD is applied and a second electrode connected to the fourth node N4. The storage capacitor CST may store the data voltage VDATA.

The boost capacitor CBST may include a first electrode connected to the fourth node N4 and a second electrode connected to the first node N1. The boost capacitor CBST may boost the voltage of the first node N1 to transmit the data voltage VDATA to the first node N1.

The light emitting element EL may include an anode electrode connected to the fifth node N5 and a cathode electrode to which a low power supply voltage ELVSS is applied. The driving current may be applied to the anode electrode, the voltage of the anode electrode may be determined based on the driving current, and a luminance of the light emitting element EL may be determined based on the voltage of the anode electrode.

A frame period for the pixel PX may include a non-emission period NEP and a emission period EP. The non-emission period NEP may be a period in which the light emitting element EL does not emit the light, and the emission period EP may be a period in which the light emitting element EL emits the light.

The non-emission period NEP may include a data initialization period DIP, a data write compensation period DWCP following the data initialization period DIP, and an anode initialization period AIP following the data write compensation period DWCP. Here, a signal EM1, EM2, GI, GC, GW, GB applied to the pixel PX may have an active level L_ACT and an inactive level L_INACT. The active level L_ACT is a level which turns on a transistor when the signal EM1, EM2, GI, GC, GW, GB is applied to a gate electrode of the transistor. The inactive level L_INACT is a level which turns off the transistor when the signal EM1, EM2, GI, GC, GW, GB is applied to the gate electrode of the transistor.

In the data initialization period DIP, the first emission signal EM1 may have the inactive level L_INACT, the second emission signal EM2 may have the active level L_ACT, the data initialization gate signal GI may have the active level L_ACT, the compensation gate signal GC may have the active level L_ACT, the data write gate signal GW may have the inactive level L_INACT, and the anode initialization gate signal GB may have the inactive level L_INACT.

In the data write compensation period DWCP, the first emission signal EM1 may have the active level L_ACT, the second emission signal EM2 may have the inactive level L_INACT, the data initialization gate signal GI may have the inactive level L_INACT, the compensation gate signal GC may have the active level L_ACT, the data write gate signal GW may have the active level L_ACT, and the anode initialization gate signal GB may have the inactive level L_INACT.

In the anode initialization period AIP, the first emission signal EM1 may have the inactive level L_INACT, the second emission signal EM2 may have the inactive level L_INACT, the data initialization gate signal GI may have the inactive level L_INACT, the compensation gate signal GC may have the inactive level L_INACT, the data write gate signal GW may have the inactive level L_INACT, and the anode initialization gate signal GB may have the active level L_ACT.

In the emission period EP, the first emission signal EM1 may have the active level L_ACT, the second emission signal EM2 may have the active level L_ACT, the data initialization gate signal GI may have the inactive level L_INACT, the compensation gate signal GC may have the inactive level L_INACT, the data write gate signal GW may have the inactive level L_INACT, and the anode initialization gate signal GB may have the inactive level L_INACT.

The voltage of the anode electrode may be initialized multiple times. Specifically, an anode initialization operation for initializing the voltage of the anode electrode may be performed in the data initialization period DIP and the anode initialization period AIP. In the data initialization period DIP, the anode initialization operation is performed such that the voltage of the anode electrode may be changed from a voltage of an anode electrode in an emission period of a previous frame period to the data initialization voltage VINT. In the anode initialization period AIP, the anode initialization operation is performed such that the voltage of the anode electrode may be changed from the data initialization voltage VINT to the anode initialization voltage VAINT. Therefore, the voltage of the anode electrode may maintain the consistency.

As such, when the voltage of the anode electrode is initialized multiple times, the voltage of the anode electrode may maintain the consistency, and a display quality may be guaranteed.

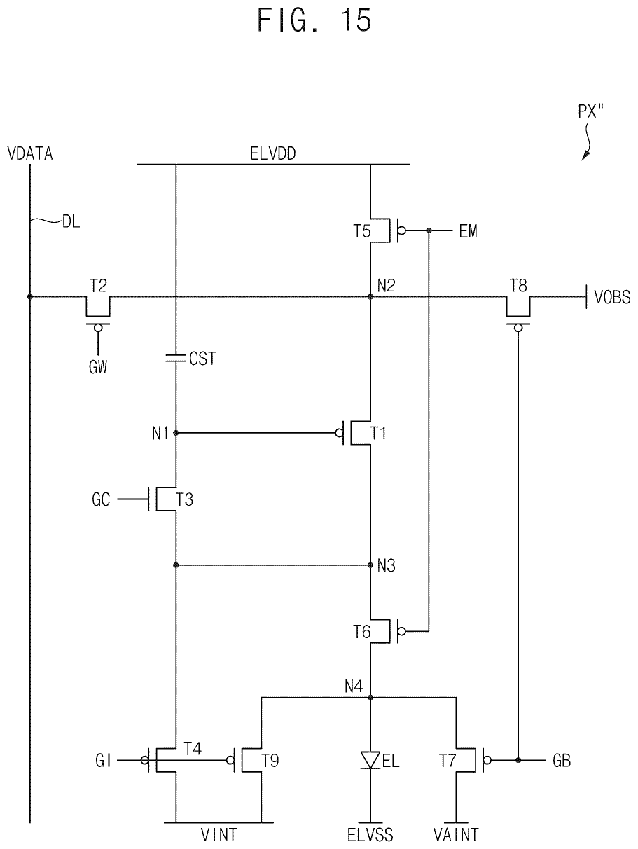

FIG. 15 is a circuit diagram showing an example PX″ of a pixel PX of FIG. 1. Although FIG. 15 illustrates various components in a pixel according to some embodiments, embodiments according to the present disclosure are not limited thereto, and according to various embodiments, the pixel may include additional components or fewer components without departing from the spirit and scope of embodiments according to the present disclosure.

Referring to FIGS. 1 to 15, the display panel 100 may include pixels PX″. Each of the pixels PX′ may include first to eighth transistors T1 to T8, a storage capacitor CST, and a light emitting element EL. However, the present disclosure is not limited to the pixel PX′ of FIG. 13. The present disclosure may be applied to various embodiments.

The first transistor T1 may include a gate electrode connected to a first node N1, a first electrode connected to a second node N2, and a second electrode connected to a third node N3. According to some embodiments, the first transistor T1 may be a PMOS transistor. The first transistor T1 may generate a driving current based on a voltage of the first node N1 and a voltage of the second node N2. The first transistor T1 may be referred to as a driving transistor.

The second transistor T2 may include a gate electrode to which a data write gate signal GW is applied, a first electrode connected to a data line DL which transmits a data voltage VDATA, and a second electrode connected to the second node N2. According to some embodiments, the second transistor T2 may be the PMOS transistor. The second transistor T2 may apply the data voltage VDATA to the second node N2 in response to the data write gate signal GW. The second transistor T2 may be referred to as a data write transistor.

The third transistor T3 may include a gate electrode to which a compensation gate signal GC is applied, a first electrode connected to the first node N1, and a second electrode connected to the third node N3. According to some embodiments, the third transistor T3 may be an NMOS transistor. The third transistor T3 may diode-connect the first transistor T1 in response to the compensation gate signal GC. The third transistor T3 may be referred to as a compensation transistor.

The fourth transistor T4 may include a gate electrode to which a data initialization gate signal GI is applied, a first electrode to which a data initialization voltage VINT is applied, and a second electrode connected to the third node N3. According to some embodiments, the fourth transistor T4 may be the PMOS transistor. The fourth transistor T4 may apply the data initialization voltage VINT to the first transistor T1 in response to the data initialization gate signal GI. The fourth transistor T4 may be referred to as a data initialization transistor.

The fifth transistor T5 may include a gate electrode to which an emission signal EMN is applied, a first electrode to which a high power supply voltage ELVDD is applied, and a second electrode connected to the second node N2. According to some embodiments, the fifth transistor T5 may be the PMOS transistor. The fifth transistor T5 may connect a high power supply voltage line which transmits the high power supply voltage ELVDD in response to the emission signal EM(N) and the second node N2. The fifth transistor T5 may be referred to as a first emission transistor.

The sixth transistor T6 may include a gate electrode to which the emission signal EM(N) is applied, a first electrode connected to the third node N3, and a second electrode connected to the fourth node N4. According to some embodiments, the sixth transistor T6 may be the PMOS transistor. The sixth transistor T6 may connect the third node N3 and the fourth node N4 in response to the emission signal EM(N). The sixth transistor T6 may be referred to as a second emission transistor.

The seventh transistor T7 may include a gate electrode to which an anode initialization gate signal GB is applied, a first electrode to which an anode initialization voltage VAINT is applied, and a second electrode connected to the fourth node N4. According to some embodiments, the seventh transistor T7 may be the PMOS transistor. The seventh transistor T7 may apply the anode initialization voltage VAINT to the fourth node N4 in response to the anode initialization gate signal GB. According to some embodiments, the data initialization voltage VINT may be greater than the anode initialization voltage VAINT. The seventh transistor T7 may be referred to as an anode initialization transistor.

The eighth transistor T8 may include a gate electrode to which the anode initialization gate signal GB is applied, a first electrode to which a bias voltage VOBS is applied, and a second electrode connected to the second node N2. According to some embodiments, the eighth transistor T8 may be the PMOS transistor. The eighth transistor T8 may apply the bias voltage VOBS to the second node N2 in response to the anode initialization gate signal GB. The eighth transistor T8 may be referred to as a bias transistor.

The ninth transistor T9 may include a gate electrode to which the data initialization gate signal GI is applied, a first electrode to which the data initialization voltage VINT is applied, and a second electrode connected to the fourth node N4. According to some embodiments, the ninth transistor T9 may be the PMOS transistor. The ninth transistor T9 may apply the data initialization voltage VINT to the fourth node N4 in response to the data initialization gate signal GI. The ninth transistor T9 may be referred to as a second data initialization transistor.

The storage capacitor CST may include a first electrode to which the high power supply voltage ELVDD is applied and a second electrode connected to the first node N1. The storage capacitor CST may store the data voltage VDATA.

The light emitting element EL may include an anode electrode connected to the fourth node N4 and a cathode electrode to which a low power supply voltage ELVSS is applied. The driving current may be applied to the anode electrode, a voltage of the anode electrode may be determined based on the driving current, and a luminance of the light emitting element EL may be determined based on the voltage of the anode electrode.

The pixel PX″ of FIG. 15 is substantially equal to the pixel PX of FIG. 2 in a configuration and an operation, except that the fifth transistor T5 and the sixth transistor T6 are turned on in response to a same emission signal EM, and a ninth transistor T9 is added. Therefore, a description of a overlapping operation is omitted.

In the pixel PX″ of FIG. 15, in a data initialization period, the ninth transistor T9 may be turned on in response to a data initialization gate signal GI having an active level to apply the data initialization voltage VINT to the fourth node N4. Therefore, in the data initialization period, a voltage of the fourth node N4 may be initialized from a voltage of an anode electrode of a light emitting element EL in an emission period of a previous frame period to the data initialization voltage VINT.

In an anode initialization period, the seventh transistor T7 may be turned on in response to an anode initialization gate signal GI having the active level to apply the anode initialization voltage VAINT to the fourth node N4. Therefore, a voltage of the fourth node N4 may be changed from the data initialization voltage VINT to the anode initialization voltage VAINT. In this case, the sixth transistor T6 is turned off in response to an emission signal EM having an inactive level L_INACT, such that the anode initialization voltage VAINT may not be applied to the third node N3 and may not affect a voltage of the third node N3.

As such, when a voltage of the anode electrode is initialized multiple times, the voltage of the anode electrode may maintain the consistency, and a display quality may be guaranteed.

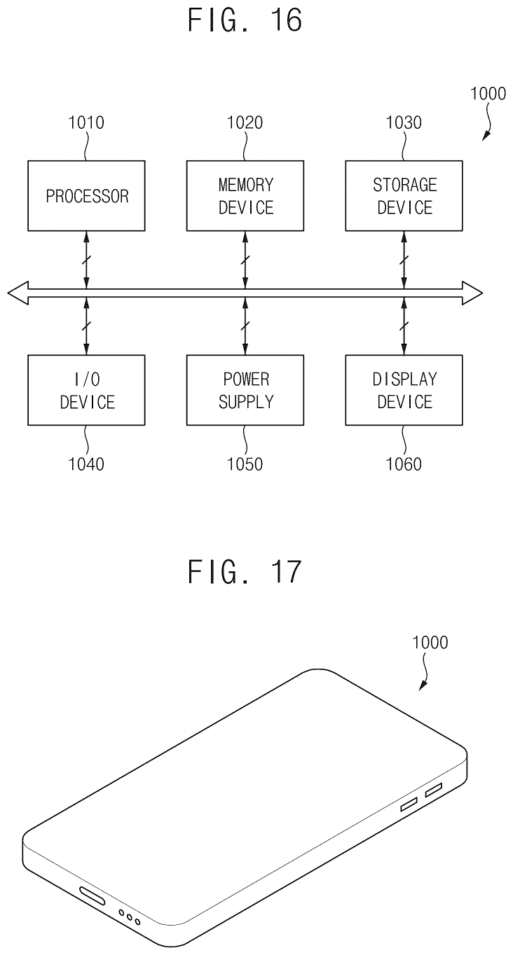

FIG. 16 is a block diagram showing an electronic device 1000. FIG. 17 is a diagram showing embodiments in which an electronic device 1000 of FIG. 16 is implemented as a smart phone.

Referring to FIGS. 16 and 17, an electronic device 1000 may include a processor 1010, a memory device 1020, a storage device 1030, an input/output I/O device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus USB device, other electronic device, and the like.

According to some embodiments, as shown in FIG. 17, the electronic device 1000 may be implemented as the smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display HMD device, and the like.

The processor 1010 may perform various computing functions. The processor 1010 may be a micro processor, a central processing unit CPU, an application processor AP, and the like. The processor 1010 may be coupled to other components via an address bus, a control bus, a data bus, and the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device such as a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

Embodiments according to the present disclosure may be applied to any display device and any electronic device including the touch panel. For example, embodiments according to the present disclosure may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

The foregoing is illustrative of aspects of some embodiments of the present disclosure and is not to be construed as limiting thereof. Although aspects of some embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A pixel driven based on a frame period including an address-scan period and a self-scan period, wherein the pixel comprises:
a data write transistor configured to output a data voltage in response to a data write gate signal;
a driving transistor configured to generate a driving current based on the data voltage;
a light emitting element including an anode electrode configured to receive the driving current, and a cathode electrode;
a data initialization transistor configured to apply a data initialization voltage to the driving transistor in response to a data initialization gate signal; and
an anode initialization transistor configured to apply an anode initialization voltage to the anode in response to an anode initialization gate signal,
wherein each of the address-scan period and the self-scan period includes a non-emission period in which the light emitting element does not emit a light and an emission period in which the light emitting element emits the light, and the non-emission period includes a data initialization period and an anode initialization period following the data initialization period, and
wherein a voltage of the anode electrode is initialized to the data initialization voltage in the address-scan period and is initialized to the anode initialization voltage in the self-scan period.

2. The pixel of claim 1, wherein the driving transistor is a PMOS transistor.

3. The pixel of claim 1, wherein, as a difference between the voltage of the anode electrode and the anode initialization voltage is below a threshold, a current which flows from the anode electrode to an anode initialization voltage line configured to transmit the anode initialization voltage decreases.

4. The pixel of claim 3, wherein the data initialization voltage is greater than the anode initialization voltage.

5. The pixel of claim 4, wherein a difference between the data initialization voltage and the anode initialization voltage is less than a difference between a voltage of an anode electrode in the emission period and the anode initialization voltage.

6. The pixel of claim 1, wherein the address-scan period further includes a data write period between the data initialization period and the anode initialization period, and
wherein, in the data write period, the data write transistor is configured to apply the data voltage to the driving transistor in response to the data write gate signal.

7. The pixel of claim 1, wherein the pixel further comprises an emission transistor configured to connect the data initialization transistor and the anode electrode in response to an emission signal, and
wherein the emission transistor is turned on to connect the data initialization transistor and the anode electrode in the data initialization period, and is turned off to separate the data initialization transistor and the anode electrode in the anode initialization period.

8. The pixel of claim 7, wherein the driving transistor includes a gate electrode connected to a first node, a first electrode connected to a second node, and a second electrode connected to a third node,
the data write transistor includes a gate electrode to which the data write gate signal is applied, a first electrode connected to a data line which transmits the data voltage, and a second electrode connected to the second node,
the data initialization transistor includes a gate electrode to which the data initialization gate signal is applied, a first electrode to which the data initialization voltage is applied, and a second electrode connected to the third node,
the emission transistor includes a gate electrode to which the emission signal is applied, a first electrode connected to the third node, and a second electrode connected to a fourth node,
the anode initialization transistor includes a gate electrode to which the anode initialization gate signal is applied, a first electrode to which the anode initialization voltage is applied, and a second electrode connected to the fourth node, and
the light emitting element includes the anode electrode connected to the fourth node and the cathode to which a low power supply voltage is applied.

9. The pixel of claim 8, wherein the pixel further comprises:
a compensation transistor configured to diode-connect the driving transistor in response to a compensation gate signal;
a second emission transistor configured to connect a high power supply voltage line which transmits a high power supply voltage and the first electrode of the driving transistor in response to a second emission signal;
a bias transistor configured to apply a bias voltage to the first electrode of the driving transistor in response to the anode initialization gate signal; and
a storage capacitor configured to store the data voltage, and
wherein the compensation transistor includes a gate electrode to which the compensation gate signal is applied, a first electrode connected to the first node, and a second electrode connected to the third node,
the second emission transistor includes a gate electrode configured to receive the second emission signal, a first electrode configured to receive the high power supply voltage, and a second electrode connected to the second node,
the bias transistor includes a gate electrode configured to receive the anode initialization gate signal, a first electrode configured to receive the bias voltage, and a second electrode connected to the second node, and
the storage capacitor includes a first electrode configured to receive the high power supply voltage and a second electrode connected to the first node.

10. The pixel of claim 7, wherein the driving transistor includes a gate electrode connected to a first node, a first electrode connected to a second node, and a second electrode connected to a third node,
the data write transistor includes a gate electrode configured to receive the data write gate signal, a first electrode connected to a data line configured to transmit the data voltage, and a second electrode connected to a fourth node,
the data initialization transistor includes a gate electrode configured to receive the data initialization gate signal, a first electrode configured to receive the data initialization voltage, and a second electrode connected to the third node,
the anode initialization transistor includes a gate electrode configured to receive the anode initialization gate signal, a first electrode configured to receive the anode initialization voltage, and a second electrode connected to a fifth node,
the emission transistor includes a gate electrode configured to receive the emission signal, a first electrode connected to the third node, and a second electrode connected to the fifth node, and
the light emitting element includes the anode electrode connected to the fifth node and the cathode electrode configured to receive a low power supply voltage.

11. The pixel of claim 10, wherein the pixel further comprises:
a compensation transistor configured to diode-connect the driving transistor in response to a compensation gate signal;
a second emission transistor configured to connect a high power supply voltage line configured to transmit a high power supply voltage and the first electrode of the driving transistor in response to a second emission signal;
a bias transistor configured to apply a bias voltage to the first electrode of the driving transistor in response to the anode initialization gate signal;
a second compensation transistor configured to connect the high power supply voltage line and the second electrode of the data write transistor in response to the compensation gate signal;
a storage capacitor configured to store the data voltage; and
a boost capacitor configured to boost a voltage of the first node, and
wherein the compensation transistor includes a gate electrode configured to receive the compensation gate signal, a first electrode connected to the first node, and a second electrode connected to the third node,
the second emission transistor includes a gate electrode configured to receive the second emission signal, a first electrode configured to receive the high power supply voltage, and a second electrode connected to the second node,
the bias transistor includes a gate electrode configured to receive the anode initialization gate signal, a first electrode configured to receive the bias voltage, and a second electrode connected to the second node,
the storage capacitor includes a first electrode configured to receive the high power supply voltage and a second electrode connected to the fourth node, and
the boost capacitor includes a first electrode connected to the fourth node and a second electrode connected to the first node.

12. The pixel of claim 1, wherein the pixel further comprises:
a first emission transistor configured to connect a high power supply voltage line configured to transmit a high power supply voltage and a first electrode of the driving transistor in response to an emission signal; and
a second emission transistor configured to connect the data initialization transistor and the anode electrode in response to the emission signal, and
wherein the driving transistor includes a gate electrode connected to a first node, the first electrode connected to a second node, and a second electrode connected to a third node,
the data write transistor includes a gate electrode to which the data write gate signal is applied, a first electrode connected to a data line configured to transmit the data voltage, and a second electrode connected to the second node,
the data initialization transistor includes a gate electrode configured to receive the data initialization gate signal, a first electrode configured to receive the data initialization voltage, and a second electrode connected to the third node,
the first emission transistor includes a gate electrode configured to receive the emission signal, a first electrode configured to receive the high power supply voltage, and a second electrode connected to the second node,
the second emission transistor includes a gate electrode configured to receive the emission signal, a first electrode connected to the third node, and a second electrode connected to a fourth node,
the anode initialization transistor includes a gate electrode configured to receive the anode initialization gate signal, a first electrode configured to receive the anode initialization voltage, and a second electrode connected to the fourth node, and
the light emitting element includes the anode electrode connected to the fourth node and the cathode electrode configured to receive a low power supply voltage.

13. The pixel of claim 12, wherein the pixel further comprises:
a compensation transistor configured to diode-connect the driving transistor in response to a compensation gate signal;
a bias transistor configured to apply a bias voltage to the first electrode of the driving transistor in response to the anode initialization gate signal;
a second data initialization transistor configured to apply the data initialization voltage to the anode electrode in response to the data initialization gate signal; and
a storage capacitor configured to store the data voltage, and
wherein the compensation transistor includes a gate electrode configured to receive the compensation gate signal, a first electrode connected to the first node, and a second electrode connected to the third node,
the bias transistor includes a gate electrode configured to receive the anode initialization gate signal, a first electrode configured to receive the bias voltage, and a second electrode connected to the second node, and
the second data initialization transistor includes a gate electrode configured to receive the data initialization gate signal, a first electrode configured to receive the data initialization voltage, and a second electrode connected to the fourth node.

14. A display device, comprising:
a display panel including a pixel configured to be driven based on a frame period including an address-scan period and a self-scan period; and
a display panel driver configured to drive the display panel,
wherein the pixel comprises:
a data write transistor configured to output a data voltage in response to a data write gate signal;
a driving transistor configured to generate a driving current based on the data voltage;
a light emitting element including an anode electrode configured to receive the driving current, and a cathode electrode;
a data initialization transistor configured to apply a data initialization voltage to the driving transistor in response to a data initialization gate signal; and
an anode initialization transistor configured to apply an anode initialization voltage to the anode in response to an anode initialization gate signal,
wherein each of the address-scan period and the self-scan period includes a non-emission period in which the light emitting element does not emit a light and an emission period in which the light emitting element emits the light, and the non-emission period includes a data initialization period and an anode initialization period following the data initialization period, and
wherein a voltage of the anode electrode is initialized to the data initialization voltage in the address-scan period and is initialized to the anode initialization voltage in the self-scan period.

15. The display device of claim 14, wherein the driving transistor is a PMOS transistor.

16. The display device of claim 14, wherein, as a difference between the voltage of the anode electrode and the anode initialization voltage is below a threshold, a current which flows from the anode electrode to an anode initialization voltage line which transmits the anode initialization voltage decreases.

17. The display device of claim 16, wherein the data initialization voltage is greater than the anode initialization voltage.

18. The display device of claim 17, wherein a difference between the data initialization voltage and the anode initialization voltage is less than a difference between a voltage of an anode electrode in the emission period and the anode initialization voltage.

19. The display device of claim 14, wherein the address-scan period further includes a data write period between the data initialization period and the anode initialization period, and
wherein, in the data write period, the data write transistor is configured to apply the data voltage to the driving transistor in response to the data write gate signal.

20. An electronic device, comprising:
a display panel including a pixel configured to be driven based on a frame period including an address-scan period and a self-scan period;
a display panel driver configured to drive the display panel; and
a power supply configured to supply a power to the display panel and the display panel driver,
wherein the pixel comprises:
a data write transistor configured to output a data voltage in response to a data write gate signal;
a driving transistor configured to generate a driving current based on the data voltage;
a light emitting element including an anode electrode to which the driving current is applied, and a cathode electrode;
a data initialization transistor configured to apply a data initialization voltage to the driving transistor in response to a data initialization gate signal; and
an anode initialization transistor configured to apply an anode initialization voltage to the anode in response to an anode initialization gate signal,
wherein each of the address-scan period and the self-scan period includes a non-emission period in which the light emitting element does not emit a light and an emission period in which the light emitting element emits the light, and the non-emission period includes a data initialization period and an anode initialization period following the data initialization period, and
wherein a voltage of the anode electrode is initialized to the data initialization voltage in the address-scan period and is initialized to the anode initialization voltage in the self-scan period.
